(19) United States
(12) Patent Application Publication
(10) Pub. No.: US 2003/0037085 A1
(43) Pub. Date: Feb. 20, 2003

(54) Field processing unit

(76) Inventor: Sam B. Sandbote, Reston, VA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/933,847

(22) Filed: Aug. 20, 2001

(51) Int. Cl. G06F 7/38

(52) U.S. Cl. 708/490

(57) ABSTRACT

The present invention is a technique to perform field operations. A mask generator generates a mask field for an operand having a word length. The mask field defines an operand field within the operand to be operated by the operation. The operand field has a field length. The execution unit executes the operation on the operand field.

### FIELD OF THE INVENTION

This invention relates to computer architecture. In particular, the invention relates to processing units.

### BACKGROUND OF THE INVENTION

Digital processors are usually designed with a fixed word length to facilitate data handling and operation. The typical word length is a power of two and is compatible with memory data size. In many advanced processors, the word length is 32-bit, 64-bit, or 128-bit.

Although these traditional word lengths are useful for many scientific, data processing, business, medical, military, and commercial applications, they may not be convenient for applications where the word length may have any size depending on the type of information to be represented. Examples of such applications include network data processing and packet communications. In these applications, the data items may be represented by the minimum word size to optimize data transfers and switching. In addition, the word size may vary within the same processing unit.

### BRIEF DESCRIPTION OF THE DRAWINGS

The features and advantages of the present invention will become apparent from the following detailed description of the present invention in which:

FIG. 1 is a diagram illustrating a system in which one embodiment of the invention can be practiced.

FIG. 2 is a diagram illustrating an instruction format for the instruction shown in FIG. 1 according to one embodiment of the invention.

FIG. 3A is a diagram illustrating a field operation according to one embodiment of the invention.

FIG. 3B is a diagram illustrating a field extraction according to one embodiment of the invention.

FIG. 3C is a diagram illustrating a field insertion according to one embodiment of the invention.

FIG. 4 is a diagram illustrating a field processing unit according to one embodiment of the invention.

FIG. 5 is a diagram illustrating a mask generator according to one embodiment of the invention.

FIG. 6 is a diagram illustrating an N-bit field arithmetic logic unit according to one embodiment of the invention.

FIG. 7 is a diagram illustrating a single bit field arithmetic logic unit according to one embodiment of the invention.

### DETAILED DESCRIPTION OF THE INVENTION

In the following description, for purposes of explanation, numerous details are set forth in order to provide a thorough understanding of the present invention. However, it will be apparent to one skilled in the art that these specific details are not required in order to practice the present invention. In other instances, well-known electrical structures and circuits are shown in block diagram form in order not to obscure the present invention.

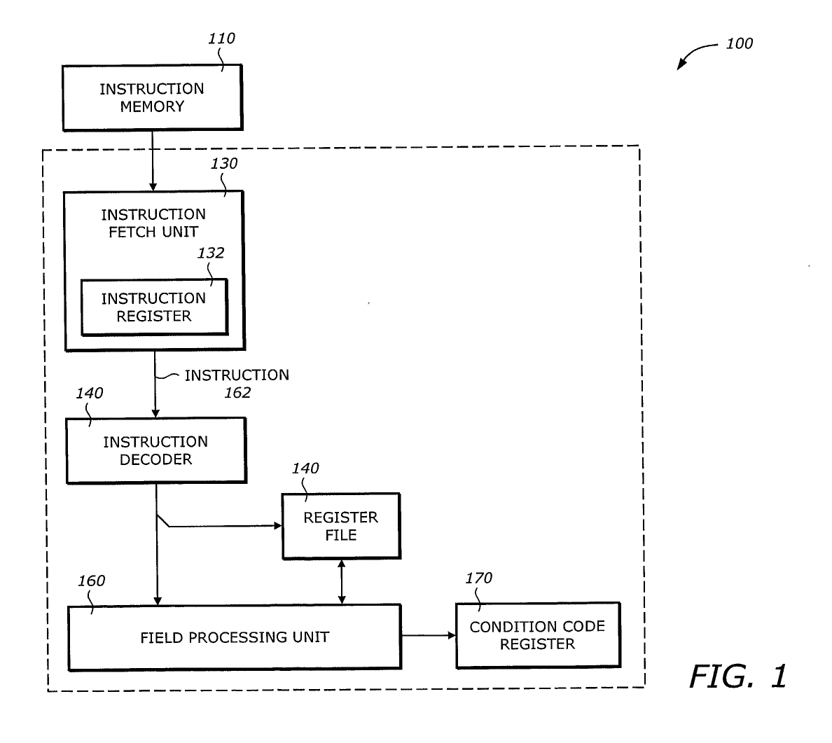

FIG. 1 is a diagram illustrating a system 100 in which one embodiment of the invention can be practiced. The system 100 includes an instruction memory 110 and a processor core 120.

The instruction memory 110 stores instructions to be fetched and executed by the processor core 120. The instruction memory 110 may be implemented by random access memory (RAM), such as static RAM (SRAM) or dynamic RAM (DRAM), or non-volatile memory such as read only memory (ROM), programmable ROM (PROM), erasable ROM (EROM), electrically erasable ROM (EEROM), flash memory, or any other storage media.

The processor core 120 is the core of a central processing unit (CPU) or a processor that can execute a program and/or instructions. The processor core 120 is interfaced to the instruction memory 110 either directly or indirectly through an interface circuit (not shown) such as a memory controller. The processor core 120 includes an instruction fetch unit 130, an instruction decoder 140, a register file 150, a field processing unit 160, and a condition code register 170. The processor core 120 may contain other circuits or elements that are not necessary for an understanding of the invention. Examples of these elements include a branch prediction logic, an instruction buffer unit, a code cache, a data cache, and other functional units.

The instruction fetch unit 130 fetches the instructions from the instruction memory 130 and stores in an instruction register 132. The instruction register holds a copy of the instruction. The instruction fetch unit 130 may contain a program counter to store the address of the instruction.

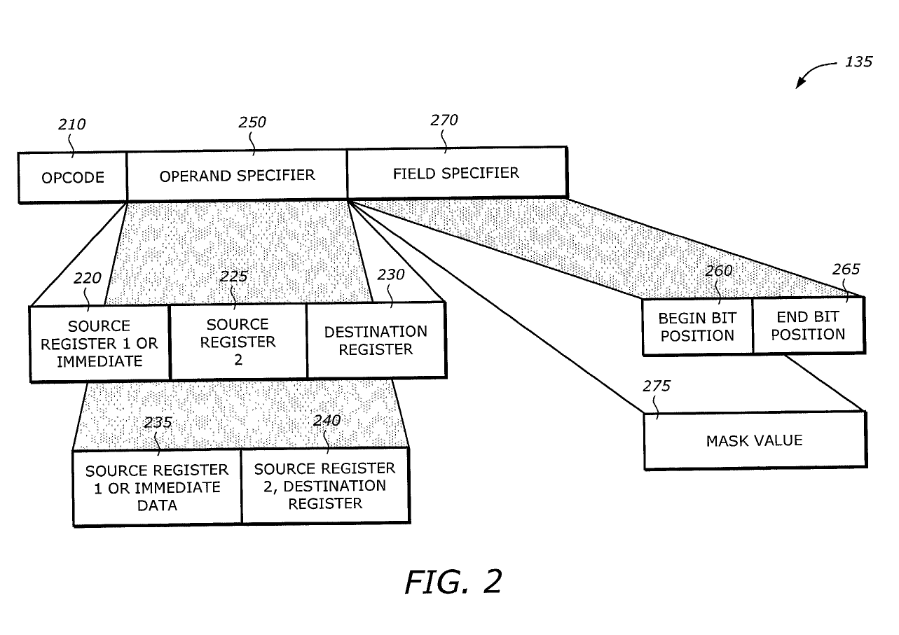

The instruction decoder 140 decodes the instruction 135 stored in the instruction register 132. The instruction decoder 140 may have a number of decoder sections that decodes portions of the instruction. The format of the instruction 135 may have a number of forms depending on the instruction set architecture (ISA) employed by the processor core 120. An exemplary format is shown in FIG. 2.

The register file 150 includes a number of registers that store temporary data to be operated on during the execution of the instruction 135. The register file may be read or written to by the field processing unit 160. The number of registers in the register file depends on the ISA and may be sixteen, thirty two, or any suitable number. The registers provide the source operands for the field processing unit 160. In addition, the registers also provide the destination for the field processing unit 160.

The field processing unit 160 performs arithmetic and/or logical operations on the operands provided by the register file 150 and/ or the immediate data provided by the instruction 135. The field processing unit 160 performs the operation within the field as defined by the instruction 135. When a field of an operand is operated upon, only the portion within the field is affected by the operation, and the portion outside the field is unchanged. The field may also be specified such that the normal word size of the operands are processed. In this manner, the field processing unit 160 is able to perform operations on any word size including the normal word size of the processor core. The field processing unit 160 also perform operations on the condition codes or bits such as carry, zero, negative, and overflow bits.

The condition code register 170 stores the condition codes or bits as generated by the field processing unit 160. The condition bits reflect the result of the operation performed by the field processing unit 160. The condition code register 170 may be used by the branch logic unit (not shown) to provide conditional branches.

FIG. 2 is a diagram illustrating an instruction format for the instruction shown in FIG. 1 according to one embodiment of the invention. The instruction format for the instruction 135 includes an opcode 210, an operand specifier 250, and a field specifier 270.

The opcode 210 is the operational code of the instruction 135 and is used to specify the operation performed by the field processing unit 160. The word size of the opcode 210 depends on the number of instructions in the ISA. Examples of operations for the opcode include arithmetic operations (e.g., add, subtract), logical operations (e.g., AND, OR. XOR, complement, shift left, shift right, rotate left, rotate right), and bit-field comparison and negation.

The operand specifier 250 specifies the operand(s) used by the field processing unit 160. Depending on the ISA, there may be three, two, or one operand. The operands may be source operands, destination operands, or any combination thereof. For a three-operand instruction set, the operands may include a first source operand 220, a second source operand 225, and a destination operand 230. The first source operand 220 may be from a register in the register file 150 (FIG. 1), or an immediate data as part of the instruction. The second source operand 225 may be a register in the register file 150, the condition code register 170, or any other suitable register in the processor core 120. The destination operand 230 may be a register in the register file 150 or any other register including the condition code register 170. A three-operand instruction may also has all three operands as source operands, or even all destination operands. For a two-operand instruction set, one of the source operands is implicitly the destination operand. For example, the first source operand 235 may be a register or an immediate data. The second operand 240 may be the second source operand or the destination operand.

The field specifier 270 specifies the field of the operands that the field processing unit 160 operates upon. The field of an operand defines the bit boundaries within which the operation operates on. The operation does not affect the bits outside the boundaries. The field specifier 270 may specify the field by several ways including static method, dynamic method, conditional method, or any combination of static, dynamic, and conditional methods. In a static approach, the field specifier 270 may specify the begin and the end bit positions 260 and 265 of the field with respect to the operand using the immediate values as part of the instruction. Another way is to directly specify the mask value defining the field. The mask value may be defined as the bit pattern where 1 indicates the field bit and 0 indicates the non-field bit. For example, a mask value of 0000 0000 1111 1000 in a 16-bit operand defines a field width of 5 bits starting from bit 3 to bit 7 where bit 0 corresponds to the least significant bit (or the rightmost bit) and bit 15 corresponds to the most significant bit (or the leftmost bit). The use of bit positions to delimit the field is preferable because it uses less number of bits in the instruction. For example, if the normal word size for the operands is 32 bits, the begin and end bit positions 260 and 265 would need only 5 bits each, for a total of 10 bits for the field specifier 270. On the other hand, a direct mask value would need the full 32 bits. Using the begin and end bit positions may require extra circuit to decode into the direct mask field value, but this extra circuit is simple and can be implemented with fast processing time as will be shown later.

In a dynamic approach, the field specifier 270 may also specify the fields using one or more special-purpose registers. These special purpose registers may be programmed, set, or manipulated during program execution. The field specifier 270 may also specify the fields from a global configuration register set at boot time. This method would specify the word size of the processor for an application-specific purpose.

In addition to any one of the above, the field specifier 270 may be manipulated using any combination of the above methods to provide an effective bit-field addressing mechanism. As in example, the begin bit position may be statically determined by the instruction, while the end bit position may be dynamically specified by a register. Furthermore, a conditional approach may be employed such that the field specifier 270 specifies the operand fields according to some condition. For example, if a condition code is asserted, the field specifier 270 may specify the begin and bit positions statically. If the condition code is negated, the field specifier 270 specifies the begin and bit positions dynamically based on contents of some predetermined special-purpose registers.

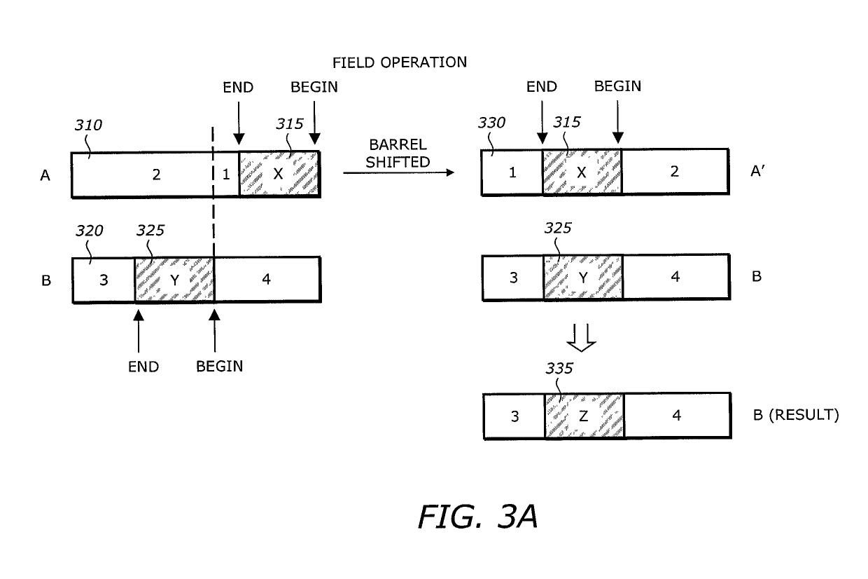

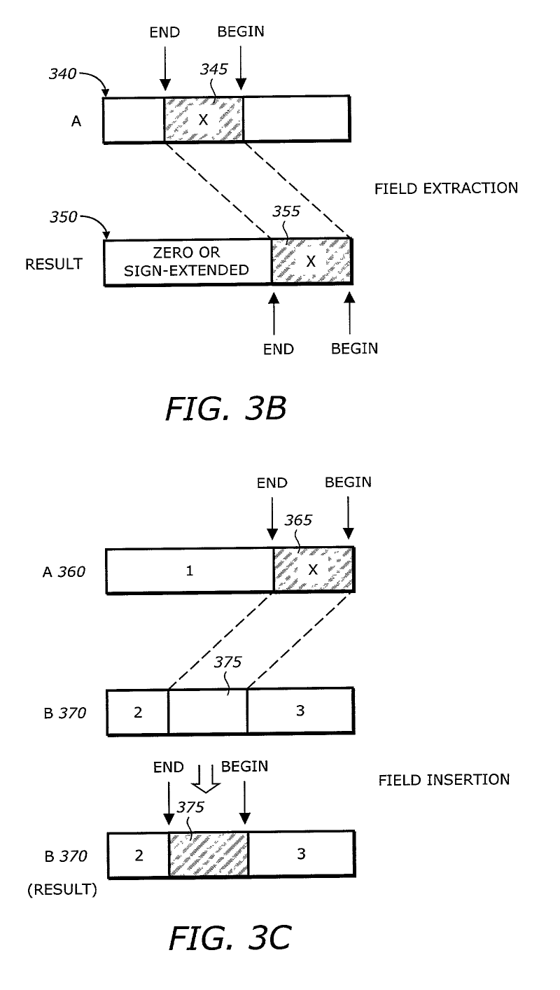

FIG. 3A is a diagram illustrating a field operation according to one embodiment of the invention. This field operation operates on two operands A 310 and B 320.

The operand A 310 has a portion X 315, 1, and 2. The operand B 320 has the portion Y 325, 3, and 4. Suppose the field specifier specifies the operation to be performed on the X and Y portions, leaving other portions unchanged. The operand A 310 is shifted by a barrel shifter to become operand A′ 330. The operand A′ 330 aligns the portion X 315 with the portion Y 325 of operand B. The operation is then performed on the portion X 315 and the portion Y 325 to produce the result Z 335 while leaving portions 3 and 4 of the operand B 320 unchanged.

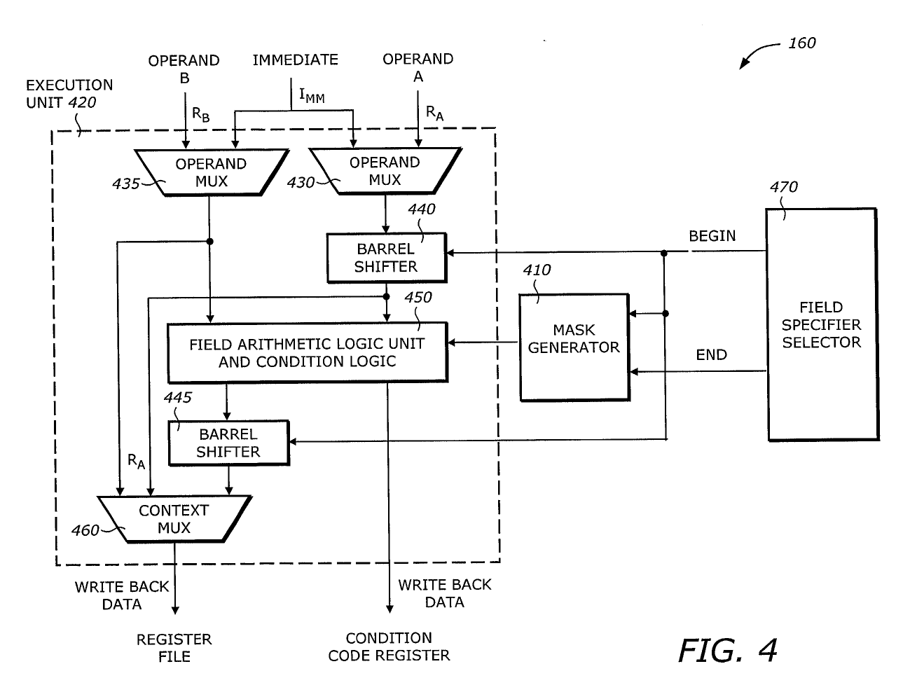

In one embodiment, the operand B 320 may be shifted right so that the field is right justified. The result is then shifted back to the original place. In this embodiment, an additional barrel shifter is used after the ALU (FIG. 4).

FIG. 3B is a diagram illustrating a field extraction according to one embodiment of the invention.

The field extraction extracts a field X 345 in an operand A 340 and deposits the extracted field X 345 into field 355 of a result operand 350. The entire operand A 340 remains unchanged. The portion outside the field 355 of the result operand may be filled with zero's, or sign-extended based on the sign bit (i.e., the most significant bit of the field 355).

FIG. 3C is a diagram illustrating a field insertion according to one embodiment of the invention.

The field insertion inserts a field X 365 of an operand A 360 into a field 375 of an operand B 370. The portions outside the field 375 of the operand B remain unchanged.

FIG. 4 is a diagram illustrating the field processing unit 160 according to one embodiment of the invention. The field processing unit 160 includes a mask generator 410, an execution unit 420, and a field specifier selector 470. The field processing unit 160 receives the operands A and B from the register file 150 (FIG. 1), the immediate data and the begin and end field specifier in the instruction or from other sources as selected by the field specifier selector 470. As discussed earlier, there are other ways to specify the begin and end positions.

The mask generator 410 generates a mask field to be used by the execution unit 420 using the begin and end field bit positions. The mask field defines an operand field within the operand to be operated by an operation performed by the execution unit 420. The operand field has a field length delimited by the begin and end field bit positions. The operand field may be contiguous or non-contiguous. The begin and end field bit positions are provided in the field specifier 270 (FIG. 2) of the instruction, or from some special-purpose registers, or from any other sources as discussed earlier. The mask field has a word size equal to the word size of the normal operands used by the execution unit 420. In one embodiment, the mask field is defined by logical 1's, i.e., the bits 1 of the mask field indicate the bit positions of the operands to be operated upon. The bits 0's of the mask field indicate that the corresponding bits of the operand remains unchanged. The mask field essentially defines the portions outside and inside the field to be operated upon. The portion outside the field may remain unchanged or modified (e.g., zero or sign extended). The mask field may or may not be contiguous. In other words, there may be holes within the field. An example of a non-contiguous mask field is 0001 1110 0111 0000 for a 16-bit operand. In other words, the mask generator 410 may generate multiple sub mask fields.

The execution unit 420 includes operand multiplexers 430 and 435, a barrel shifter 440, a field arithmetic logic unit (ALU) 450, an optional barrel shifter 455, and a context multiplexer 460. The operand multiplexer 430 selects one of the source operands from the operand A (RA) and the immediate data (Imm). The operand multiplexer 435 selects one of the source operands from the operand B (RB) and the immediate data (Imm). The barrel shifter 440 shifts the selected operand by a number of bits defined by the begin bit position. The barrel shifter 440 may pass the selected operand unchanged.

The field ALU 450 performs arithmetic and/or logical operations on the operand B and the operand provided by the barrel shifter 440. The field ALU 450 has a condition logic to generate the condition codes or condition bits such as carry, zero, negative, and overflow bits according to the result of the operation. The updated condition codes or bits are then written into the condition code register 170 (FIG. 1).

The optional barrel shifter 455 shifts the result back to the original bit position when the operand B is right field justified as discussed earlier. The barrel shifter 455 may also allow the ALU result to pass through unshifed. In addition, other barrel shifters may be employed to shift the operand B accordingly.

The context multiplexer 460 selects bits of the output of the operand multiplexer 435, the result of the barrel shifter 440, or the result of the field ALU 450 to produce a result operand to be written back to the register file 150 or any other specified destination register. In one embodiment, the context multiplexer 460 operates on a bit-by-bit basis. If the bit is inside the mask field, it is passed through. If the bit is outside the mask field, it is restored back to the original unrelated context from the operand B. It is also noted that the ALU output for the bits outside the mask field should be considered invalid.

The operation of the barrel shifters 440 and 455 and the context multiplexer 460 may be carried out in two ways.

In the first way, the barrel shifter 455 is not needed, or it can be made inactive and merely passes the ALU result to the context multiplexer 460. The operand B contains the field of interest and the operand A (or the immediate data) contains a second right-justified operand. The barrel shifter 440 shifts the operand A to align with the field of interest in the operand B. The field ALU 450 then operates on these two operands and produce an ALU result. The barrel shifter 455 is not used and passes the ALU result to the context multiplexer 460. The context multiplexer 460 selects from the ALU result, the shifted operand A, and the operand B.

In the second way, the operand A contains the field of interest and the operand B (or the immediate data) contains the second right-justified operand. The barrel shifter 440 shifts the operand A to align with the right-justified operand in operand B. The field AUL 450 then operates on these two operands and produces an ALU result. The ALU result is right-justified. Note that since both operands are right-justified, the field ALU 450 may be an ordinary ALU working on right-justified operands. The barrel shifter 455 is active to shift the ALU result back to the same position of the field of interest in the original operand A. The context multiplexer 460 selects from the output of the barrel shifter 455 (i.e., the shifted ALU result), the shifted operand A, and the operand B.

The field specifier selector 470 selects the source of the field specifier. The source of the field specifer may be directly from the instruction, from other special-purpose registers, or from a global configuration register set at boot time, or any dynamic effective bit-field mechanism as discussed earlier.

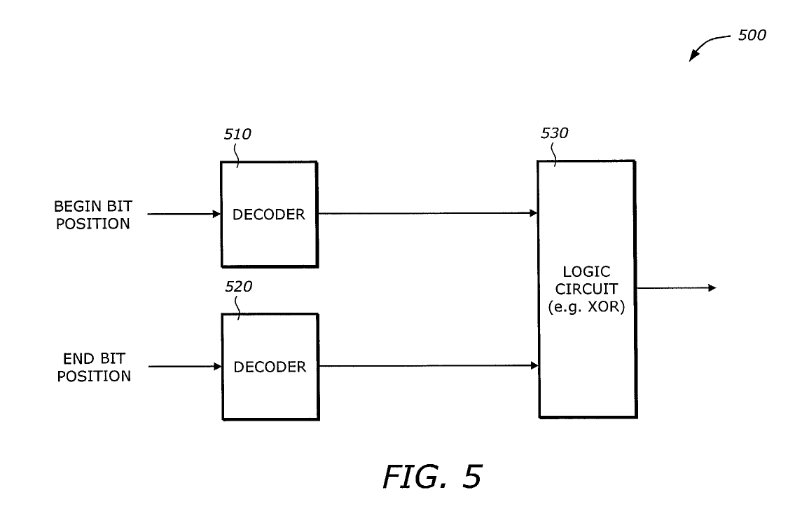

FIG. 5 is a diagram illustrating the mask generator 410 according to one embodiment of the invention. The mask generator 410 includes a begin encoder 510, an end encoder 520, and a logic circuit 530.

The begin decoder 510 encodes the begin bit position b to produce a bit pattern having a word size equal to the normal word size of the field ALU 450 (FIG. 4). The bit pattern includes a consecutive one bits starting from the LSB to the begin bit position b minus 1. The remaining bits are zero's. For example, if the normal word size is 16 bits and the begin bit position is 4, then the bit pattern generated by the begin decoder 510 is 0000 0000 0000 1111.

The end decoder 510 is essentially the same as the begin decoder 510, except that the decoding is performed on the end bit position, and the bit pattern includes consecutive one bits starting from the LSB to the end bit position e. For example, if the end bit position is 10 for a 16-bit normal word size, then the bit pattern generated by the end decoder 510 is0000 0111 1111 1111.

The logic circuit 530 combines the decoded begin and end bit patterns to generate the mask field. In one embodiment, the logic circuit 530 may be an exclusive-OR (XOR gate). For example, if the begin and end bit patterns are 0000 0000 0000 1111 and 0000 0111 1111 1111, respectively, then the logic circuit 530 generates the mask field having a value 0000 0111 1111 0000.

In addition, the decoders 510 and 520 may decode multiple begin and end bit positions to implement non-contiguous mask field.

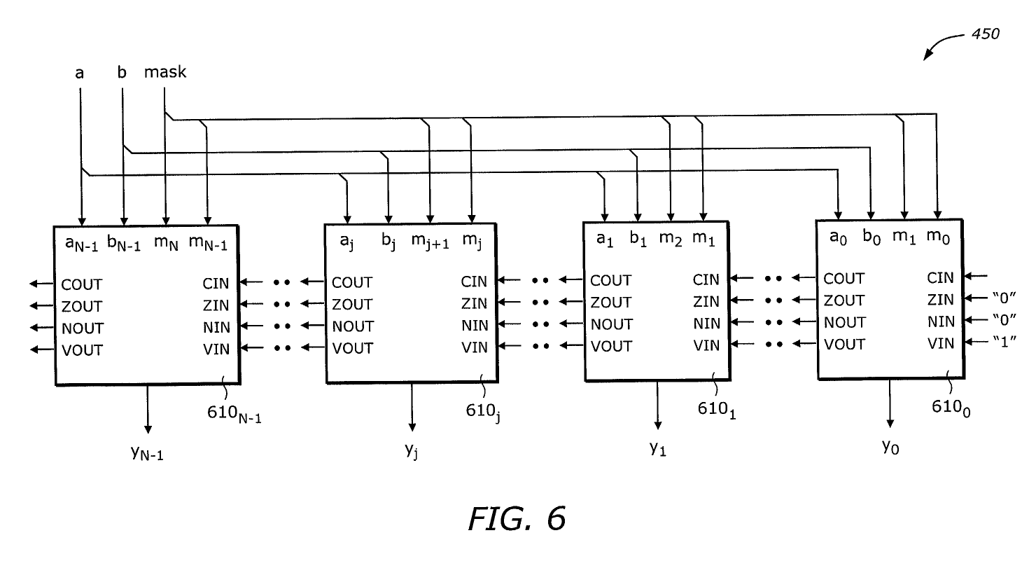

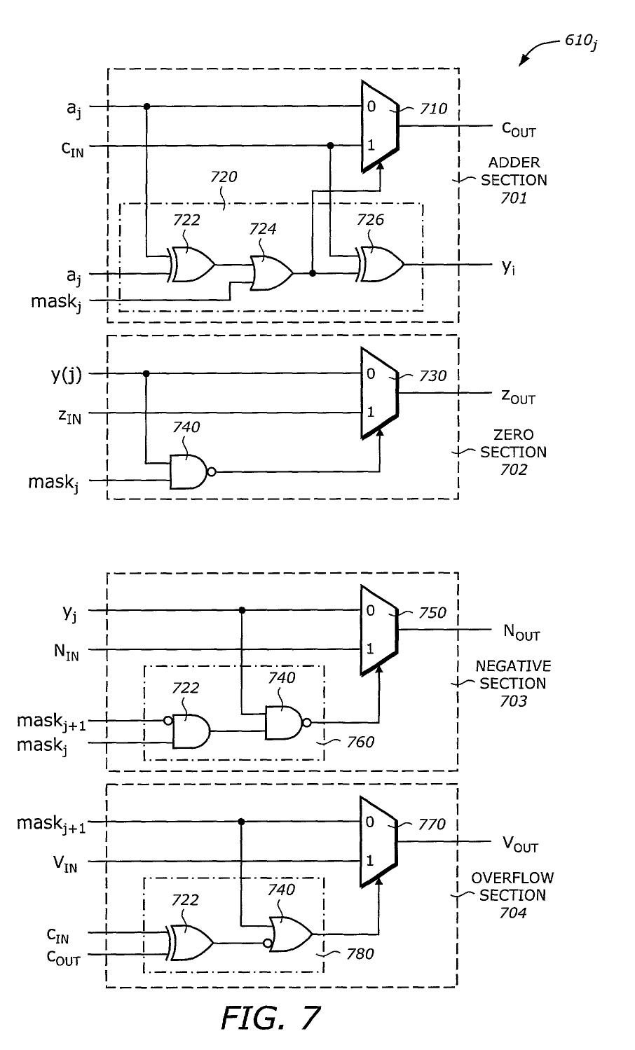

FIG. 6 is a diagram illustrating an N-bit field arithmetic logic unit 450 according to one embodiment of the invention. The N-bit ALU 450 includes N 1-bit ALU 610₀ to 610_{N-1}.

The N 1-bit ALU 610₀ to 610_{N-1} are identical and are connected in cascade. The inputs to each of the N 1-bit ALU 610₀ to 610_{N-1} include a carry input (CIN), a zero input (ZIN), a negative input (NIN), an overflow input (VIN), two operand a(j) and b(j), and the mask field bits mask(j) and mask(j+1). The outputs of the N 1-bit ALU 610₀ to 610_{N-1} include a carry output (COUT), a zero output (ZOUT), a negative output (NOUT), an overflow output (VOUT), and a result bit y(j).

In one embodiment, the N 1-bit ALU 610₀ to 61o_{N-1} are connected in cascade such that the outputs COUT, ZOUT, NOUT, and VOUT of a stage are connected to the inputs CIN, ZIN, NIN, and VIN of the next significant stage, respectively. The inputs CIN, ZIN, NIN, and VIN to the least significant stage 610₀ are connected to carry in, “1”, “0”, and “0”, respectively. The outputs COUT, ZOUT, NOUT, and VOUT of the most significant stage 610_{N-1} are the final outputs of the result. In other embodiments, the condition detection logic may be implemented in parallel and does not necessarily ripple along with the carry. In addition, any of the techniques for fast adders such as carry-save, carry-skip, carry-select, and carry-lookahead may be employed.

FIG. 7 is a diagram illustrating a single bit field arithmetic logic unit according to one embodiment of the invention. The single bit field ALU 610 includes an adder section 701, a zero section 702, a negative section 703, and an overflow section 704. Each of these sections is conditioned or masked by the mask field bits mask(j) and/or mask(j+1)

The adder section 701 performed a single bit addition on the two bits a(j) and b(j) and the carry input CIN, and produces the sum bit y(j) and the carry output COUT. The adder section 701 includes an exclusive-OR gate 722, an OR gate 724, an exclusive-OR gate 726, and a selector 710. The exclusive OR gate 722 performs a half adding operation on the two operand bits a(j) and b(j). The OR gate 724 masks the half adder result by the mask bit mask(j). The masked result is used as the control bit for the selector 710. The exclusive OR gate 726 combines the masked result with the CIN to produce the final adder output y(j).

The selector 710 is a multiplexer to select the operand bit a(j) and the CIN according to the control bit from the masked result. When the control bit is zero, the a(j) bit is selected as the COUT. When the control bit is one, the CIN is selected as the COUT.

The zero section 702 determines the zero condition bit of the result of the operation. It includes a NAND gate 740 and a selector 730. The NAND gate 740 generates the control signal for the selector 730 based on the mask bit mask(j) and the result bit y(j).

The negative section 703 determines the negative bit, or sign bit, of the result of the operation. It includes a logic circuit 760 and a selector 750. If the current mask bit mask(j) is zero indicating that the current result bit y(j) is not part of the field, the logic circuit 760 selects the NIN as the NOUT. If the current mask bit mask(j) is one indicating the current result bit y(j) is part of the field and the next significant mask bit mask(j+1) is zero, indicating the current result bit y(j) is the most significant bit, the logic circuit 760 selects the current result bit y(j) as the NOUT.

The overflow section 704 determines the overflow bit using the carry output of the current result bit COUT and the carry output of the previous section CIN. It includes a logic circuit 780 and a selector 770.

While this invention has been described with reference to illustrative embodiments, this description is not intended to be construed in a limiting sense. Various modifications of the illustrative embodiments, as well as other embodiments of the invention, which are apparent to persons skilled in the art to which the invention pertains are deemed to lie within the spirit and scope of the invention.

What is claimed is:

1. An apparatus comprising:
a mask generator to generate a mask field for an operand having a word length, the mask field defining an operand field within the operand to be operated by an operation, the operand field having a field length; and
an execution unit coupled to the mask generator to execute the operation on the operand field.

2. The apparatus of claim 1 wherein the mask generator comprises:
a first decoder to decode a begin position specifier into a begin bit pattern;
a second decoder to decode an end position specifier into an end bit pattern; and
a logic circuit coupled to the first and second decoders to combine the begin and end bit patterns into the mask field having the field length limited by the begin and end positions.

3. The apparatus of claim 1 wherein the execution unit comprises:
a field arithmetic logic unit (ALU) to generate an ALU result using one of an arithmetic and logic operations on the operand field of at least one of first and second ALU operands.

4. The apparatus of claim 3 wherein the execution unit further comprises:
an operand selector to select a selector operand from a source operand and an immediate operand, the source operand being from a register file.

5. The apparatus of claim 4 wherein the execution unit further comprises:
a first barrel shifter coupled to the operand selector to shift the selector operand to generate the first ALU operands according to one of the begin and end positions.

6. The apparatus of claim 5 wherein the execution unit further comprises:
a second barrel shifter coupled to the field ALU to shift the ALU result.

7. The apparatus of claim 5 wherein the execution unit further comprises:
a context selector coupled to the field ALU to select a field result, on a bit-by-bit basis according to the operand field, from at least one of the first and second ALU operands and the ALU result.

8. The apparatus of claim 6 wherein the execution unit further comprises:
a context selector coupled to the field ALU to select a field result, on a bit-by-bit basis according to the operand field, from at least one of the first and second ALU operands, the ALU result, and the shifted ALU result.

9. The apparatus of claim 3 wherein the field ALU comprises:
N single bit ALUs connected in cascade to generate the field result, the field result including a single bit ALU result.

10. The apparatus of claim 9 wherein the field result includes at least a condition code representing a condition of the field result.

11. The apparatus of claim 9 wherein the single bit ALU comprises:
an adder/subtractor to perform an add/subtraction on the first and second ALU operands and generate a carry output.

12. The apparatus of claim 11 wherein the single bit ALU further comprising:
a zero section to generate a zero condition code using a carry from a less significant section;
a negative section to generate a out sign bit for the field result using current and next operand fields; and
an overflow section to generate an overflow bit for the field result using the next operand field.

13. The apparatus of claim 2 further comprising:
a field specifier selector coupled to the mask generator to generate at least one of the begin and end position specifiers.

14. The apparatus of claim 13 wherein the field specifier selector generates the at least one of the begin and end position specifiers from at least one of an instruction specifying the operation, a general-purpose register, a special-purpose register, and a configuration register.

15. The apparatus of claim 1 wherein the operand field is one of a contiguous field and a non-contiguous field.

16. A method comprising:
generating a mask field for an operand having a word length, the mask field defining an operand field within the operand to be operated by an operation, the operand field having a field length; and
executing the operation on the operand field, leaving portion outside the operand field unchanged.

17. The method of claim 16 wherein generating the mask field comprises:
decoding a begin position specifier into a begin bit pattern;
decoding an end position specifier into an end bit pattern; and
combining the begin and end bit patterns into the mask field having the field length limited by the begin and end positions.

18. The method of claim 16 wherein executing the operation comprises:
generating an ALU result using one of an arithmetic and logic operations on the operand field of at least one of first and second ALU operands.

19. The method of claim 18 wherein executing the operation further comprises:
selecting a selector operand from a source operand and an immediate operand, the source operand being from a register file.

20. The method of claim 19 wherein executing the operation further comprises:
shifting the selector operand to generate the first ALU operands according to one of the begin and end positions.

21. The method of claim 20 wherein executing the operation further comprises:
shifting the ALU result.

22. The method of claim 20 wherein executing the operation comprises:
selecting a field result, on a bit-by-bit basis according to the operand field, from the first and second ALU operands and the ALU result.

23. The method of claim 21 wherein executing the operation comprises:
selecting a field result, on a bit-by-bit basis according to the operand field, from the first and second ALU operands, the ALU result, and the shifted ALU result.

24. The method of claim 23 wherein generating the ALU result comprises:
generating the field result using N single bit ALUs connected in cascade, the field result including a single bit ALU result.

25. The method of claim 24 wherein the field result includes at least a condition code representing a condition of the field result.

26. The method of claim 24 wherein generating the field result comprises:
performing an add/subtraction on the first and second ALU operands; and
generating a carry output.

27. The method of claim 26 wherein generating the field result further comprises:
generating a zero condition code using a carry from a less significant section;
generating a sign bit for the field result using current and next operand fields; and
generating an overflow bit for the field result using the next operand field.

28. The method of claim 17 further comprising:
generating at least one of the begin and end position specifiers using a field specifier selector.

29. The method of claim 28 wherein generating at least one of the begin and end position specifiers comprises generating the at least one of the begin and end position specifiers from at least one of an instruction specifying the operation, a general-purpose register, a special-purpose register, and a configuration register.

30. The method of claim 16 wherein the operand field is one of a contiguous field and a non-contiguous field.

31. A processor core comprising:
a register file having a plurality of registers;
a condition code register to store condition codes resulted from an operation; and
a field processing unit coupled to the register file and the condition code register to perform an operation, the field processing unit comprising:
a mask generator to generate a mask field for an operand having a word length, the mask field defining an operand field within the operand to be operated by the operation, the operand field having a field length, and
an execution unit coupled to the mask generator to execute the operation on the operand field, leaving portion outside the operand field unchanged.

32. The processor core of claim 31 wherein the mask generator comprises:
a first decoder to decode a begin position specifier into a begin bit pattern;
a second decoder to decode an end position specifier into an end bit pattern; and
a logic circuit coupled to the first and second decoders to combine the begin and end bit patterns into the mask field having the field length limited by the begin and end positions.

33. The processor core of claim 31 wherein the execution unit comprises:
a field arithmetic logic unit (ALU) to generate an ALU result using one of an arithmetic and logic operations on the operand field of at least one of first and second ALU operands.

34. The processor core of claim 33 wherein the execution unit further comprises:
an operand selector to select a selector operand from a source operand and an immediate operand, the source operand being from a register file.

35. The processor core of claim 34 wherein the execution unit further comprises:
a first barrel shifter coupled to the operand selector to shift the selector operand to generate the first ALU operands according to one of the begin and end positions.

36. The processor core of claim 34 wherein the execution unit further comprises:
a second barrel shifter coupled to the operand selector to shift the ALU result.

37. The processor core of claim 35 wherein the execution unit further comprises:
a context selector coupled to the field ALU to select a field result, on a bit-by-bit basis according to the operand field, from at least one of the first and second ALU operands and the ALU result.

38. The processor core of claim 36 wherein the execution unit further comprises:
a context selector coupled to the field ALU to select a field result, on a bit-by-bit basis according to the operand field, from at least one of the first and second ALU operands, the ALU result, and the shifted ALU result.

39. The processor core of claim 36 wherein the field ALU comprises:
N single bit ALUs connected in cascade to generate the field result, the field result including a single bit ALU result.

40. The processor core of claim 39 wherein the field result includes at least a condition code representing a condition of the field result.

41. The processor core of claim 39 wherein the single bit ALU comprises:
an adder/subtractor to perform an add/subtraction on the first and second ALU operands and generate a carry output.

42. The processor core of claim 41 wherein the single bit ALU further comprising:
a zero section to generate a zero condition code using a carry from a less significant section;
a negative section to generate a out sign bit for the field result using current and next operand fields; and
an overflow section to generate an overflow bit for the field result using the next operand field.

43. The processor core of claim 32 wherein the field processing unit further comprises:
a field specifier selector coupled to the mask generator to generate at least one of the begin and end position specifiers.

44. The processor core of claim 43 wherein the field specifier selector generates the at least one of the begin and end position specifiers from at least one of an instruction specifying the operation, a general-purpose register, a special-purpose register, and a configuration register.

45. The processor core of claim 31 wherein the operand field is one of a contiguous field and a non-contiguous field.
